(19) United States
(12) Patent Application Publication
(10) Pub. No.: US 2009/0044249 A1
(43) Pub. Date: Feb. 12, 2009

(54) SYSTEMS, METHODS AND COMPUTER PRODUCTS FOR A SECURITY FRAMEWORK TO REDUCE ON-LINE COMPUTER EXPOSURE

(75) Inventors: Jinmei Shen, Rochester, MN (US); Hao Wang, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/837,012

(22) Filed: Aug. 10, 2007

(51) Int. Cl. G06F 21/00

(52) U.S. Cl. 726/3

(57) ABSTRACT

Systems, methods and computer products for a security framework to reduce on-line computer exposure. Exemplary embodiments include a computer security method, including initiating a computer session on a first computer, receiving a grace period entry into the first computer, monitoring mouse and keyboard on the first computer activity during the computer session, monitoring long-running jobs initiated on the first computer during the computer session, monitoring authorized computer access of a plurality of computers to the first computer, determining which computers of the plurality of computers can access the first computer and for what time period and terminating computer traffic related to the first computer in response to an expiration of the grace period.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to computer security, and particularly to systems, methods and computer products for a security framework to reduce on-line computer exposure.

2. Description of Background

With cable modem, DSL, and Internet popularity, many home computers and business computers are always connected to the Internet. As such, this constant connection presents risks to on-line computers. One risk is that data on the computer is subject to theft. Another risk is that the connected computers are subject to attack from online threats such as viruses. Even with firewalls, virus protection software and other precautions, newer and more sophisticated attacks are a constant threat. Moreover, it has been speculated that for the 100% of time that computers remain powered on and connected to external networks such as the Internet, only 20% of the time is spent for utilization, leaving the computers exposed to threats for 80% of the powered on and connected time.

There exists a need for a security framework that reduces on-line computer exposure.

### SUMMARY OF THE INVENTION

Exemplary embodiments include a computer security method, including initiating a computer session on a first computer, receiving a grace period entry into the first computer, monitoring mouse and keyboard on the first computer activity during the computer session, monitoring long-running jobs initiated on the first computer during the computer session, monitoring authorized computer access of a plurality of computers to the first computer, determining which computers of the plurality of computers can access the first computer and for what time period and terminating computer traffic related to the first computer in response to an expiration of the grace period.

Further exemplary embodiments include a computer security system, including computer processor coupled to a memory having instructions for initiating a computer session on a first computer, receiving a grace period entry into the first computer, monitoring mouse and keyboard on the first computer activity during the computer session, monitoring long-running jobs initiated on the first computer during the computer session, monitoring authorized computer access of a plurality of computers to the first computer, determining which computers of the plurality of computers can access the first computer and for what time period and terminating computer traffic related to the first computer in response to an expiration of the grace period, wherein the computer traffic related to the first computer is terminated in response to at least one of detecting no activity from the keyboard during the grace period and detecting no activity from the mouse during the grace period.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that provides a security framework for reducing threats from on-line computer exposure.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary embodiment of a system for a security framework to reduce on-line computer exposure; and

FIG. 2 illustrates a flow chart of a method 200 for reduction of on-line exposure.

The detailed description explains the preferred embodiments of the invention, together with advantages and features, by way of example with reference to the drawings.

### DETAILED DESCRIPTION OF THE INVENTION

Exemplary embodiments include systems and methods for network and computer traffic control that is based on key-board/mouse or user-specified time periods. In exemplary embodiments, the time-based security control systems and methods specify time periods beyond which an inactive time, the system restricts outgoing traffic to prevent data loss/theft to unauthorized parties and for refusing incoming traffic to prevent viruses or other external threats. As such, exemplary embodiments include systems and methods having security components that are computer utilization-based and activity-based period-differentiation.

In exemplary embodiments, one or more processes are implemented to monitor keyboard and mouse activity, long-running jobs submitted with the keyboard or mouse, and authorized remote machine access. Furthermore, the processes can control how many machines can control the online computer and for how long the online computer can be controlled by the remote machines. The processes can further accept a grace period input by the online computer user. In exemplary embodiments, incoming traffic is terminated after a grace period of inactivity. Similarly, outgoing traffic is terminated after a grace period of inactivity. In further exemplary, embodiments, common network maintenance control is permitted for network service such as addressing timing.

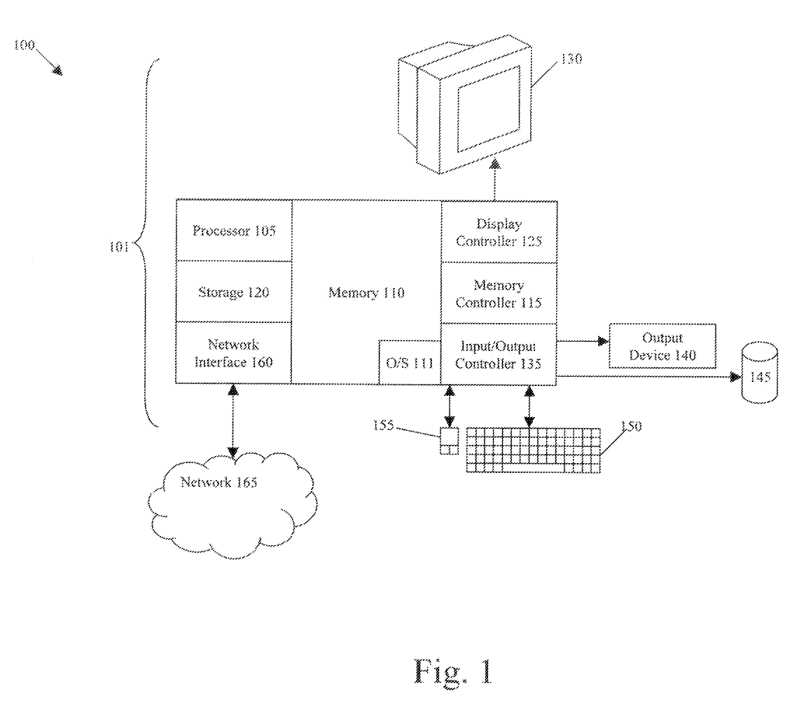

FIG. 1 illustrates an exemplary embodiment of a system 100 for a security framework to reduce on-line computer exposure. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 100 therefore includes general-purpose computer 101.

In exemplary embodiments, in terms of hardware architecture, as shown in FIG. 1, the computer 101 includes a processor 101, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 14 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 1, the software in the memory 110 includes the security framework methods described herein in accordance with exemplary embodiments and a suitable operating system (O/S) 111. The operating system 111 essentially controls the execution of other computer programs, such the security framework systems and methods described herein, and provides scheduling, input-output control, file and data management, memory management, and communication control and related services.

The security framework methods described herein may be in the form of a source program, executable program (object code), script, or any other entity comprising a set of instructions to be performed. When a source program, then the program needs to be translated via a compiler, assembler, interpreter, or the like, which may or may not be included within the memory 110, so as to operate properly in connection with the O/S 111. Furthermore, the security framework methods can be written as an object oriented programming language, which has classes of data and methods, or a procedure programming language, which has routines, subroutines, and/or functions.

In exemplary embodiments, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a NIC or modulator/demodulator (for accessing other files, devices, systems, or a network), a radio frequency (RF) or other transceiver, a telephonic interface, a bridge, a router, and the like. The system 100 can further include a display controller 125 coupled to a display 130. In exemplary embodiments, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the software in the memory 110 may further include a basic input output system (BIOS) (omitted for simplicity). The BIOS is a set of essential software routines that initialize and test hardware at startup, start the O/S 11, and support the transfer of data among the hardware devices. The BIOS is stored in ROM so that the BIOS can be executed when the computer 101 is activated.

When the computer 101 is in operation, the processor 105 is configured to execute software stored within the memory 110, to communicate data to and from the memory 110, and to generally control operations of the computer 101 pursuant to the software. The security framework methods described herein and the O/S 22, in whole or in part, but typically the latter, are read by the processor 105, perhaps buffered within the processor 105, and then executed.

When the systems and methods described herein are implemented in software, as is shown in FIG. 1, it the methods can be stored on any computer readable medium, such as storage 120, for use by or in connection with any computer related system or method. In the context of this document, a computer readable medium is an electronic, magnetic, optical, or other physical device or means that can contain or store a computer program for use by or in connection with a computer related system or method. The security framework methods described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In exemplary embodiments, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In exemplary embodiments, where the security framework methods are implemented in hardware, the security framework methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In exemplary embodiments, one or more processes in the memory 110 can monitor activity from the keyboard 150 and the mouse 155 or a combination thereof. The processes can further monitor long-running jobs that have been initiated on the computer 101. The processes can further monitor which and how many other machines can control the computer 101 either locally or remotely. In exemplary embodiments, the processes can also inquire or accept a grace period input by a user of the computer 101. The grace period can be a time period after which all traffic to and from the computer ceases if no further activity has been sensed by the processes. In this way, if a user has left the computer 101 for an extended period of time or has left the computer (e.g., after a work day) the computer 101 no longer allows traffic to and from the computer 101. In an alternative implementation, the computer 101 can totally power down after the grace period has expired. In further exemplary embodiments, the processes can accept traffic only from a common network maintenance control system that provides limited services.

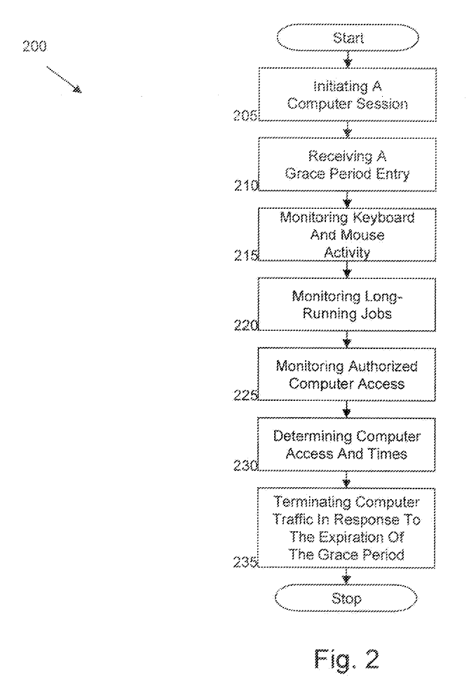

FIG. 2 illustrates a flow chart of a method 200 for reduction of on-line exposure. At step 205, a computer session is initiated on an online computer. At step 210, the user can input a grace period into the online computer. In exemplary embodiments, the user also can skip this step and the security framework uses system default values or user modifiable saved values from previous sessions. It is therefore appreciated that either system defaults or previously saved values can be used at step 210. The method 200 then monitors mouse and keyboard on the online computer activity during the computer session at step 215. Furthermore, the method 200 monitors long-running jobs initiated on the online computer during the computer session at step 220. In addition, the method 200 monitors authorized computer access of other online computers to the online computer at step 225. At step 230, the method 200 further determines which other online computers can access the online computer and for what time period with what levels of authority. At step 235, the method 200 terminates computer traffic related to the online computer in response to the expiration of the grace period. In exemplary embodiments, the computer traffic related to the online computer is terminated in response to several events including but not limited to detecting no activity from the keyboard during the grace period and detecting no activity from the mouse during the grace period. Furthermore, the incoming traffic, which can include data resident to the online computer that is subject to theft, terminates after the grace time of inactivity. In addition, outgoing traffic, which can include external threats that can cause damage to the online computer, terminates after the grace period of inactivity. As discussed further below, further exemplary embodiments include internet maintenance service such as network time service and others as an option such that users can choose to leave the services open while the security framework monitors its well defined traffic patterns while denying all other traffic while the online computer is not in use

In exemplary embodiments, the user can choose to open only well-defined Internet maintenance services such as network time services. As such, all other traffic is turned off in the computer network interface, in both incoming and outgoing directions, and the security framework allows only Internet maintenance services with well-defined patterns. The security framework further checks the patterns before allowing these packets to go through to the online computer. Since these Internet maintenance services are slow, the security framework also checks packet time characteristics to periodically permit these patterns according to the timeout value and inactivity period. In exemplary embodiments, the user can customize these features with services, patterns, periods, etc. In exemplary embodiments, the user also can choose to turn off these additional functions so that on-line computer incoming traffic and outgoing traffic are completely turned off during inactivity period, which makes the online computer automatically isolated. Furthermore, upon activity from the user, the computer immediately reconnects online

The capabilities of the present invention can be implemented in software, firmware, hardware or some combination thereof.

As one example, one or more aspects of the present invention can be included in an article of manufacture (e.g., one or more computer program, products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer security method, consisting of:
initiating a computer session on a first computer;
receiving a grace period entry into the first computer;
monitoring mouse and keyboard on the first computer activity during the computer session;
monitoring long-running jobs initiated on the first computer during the computer session;
monitoring authorized computer access of a plurality of computers to the first computer;
determining which computers of the plurality of computers can access the first computer and for what time period; and
terminating computer traffic related to the first computer in response to an expiration of the grace period.

2. The method as claimed in claim 1 wherein computer traffic related to the first computer is terminated in response to at least one of detecting no activity from the keyboard during the grace period and detecting no activity from the mouse during the grace period.

3. The method as claimed in claim 2 wherein computer traffic related to the first computer includes:
incoming traffic that terminates after the grace time of inactivity; and
outgoing traffic that terminates after the grace period of inactivity.

4. The method as claimed in claim 3 wherein incoming traffic includes external threats that can cause damage to the first computer and outgoing traffic includes data resident to the first computer that is subject to theft.

5. The method, as claimed in claim 4 further consisting of permitting access to the first computer from a service computer.

6. A computer security system, comprising:
a computer processor coupled to a memory having instructions for:
initiating a computer session on a first computer;
receiving a grace period entry into the first computer;
monitoring mouse and keyboard on the first computer activity during the computer session;
monitoring long-running jobs initiated on the first computer during the computer session;
monitoring authorized computer access of a plurality of computers to the first computer;
determining which computers of the plurality of computers can access the first computer and for what time period; and
terminating computer traffic related to the first computer in response to an expiration of the grace period, wherein the computer traffic related to the first computer is terminated in response to at least one of detecting no activity from the keyboard during the grace period and detecting no activity from the mouse during the grace period.

7. The system as claimed in claim 6 wherein computer traffic related to the first computer is terminated in response to at least one of detecting no activity from the keyboard during the grace period and detecting no activity from the mouse during the grace period, and wherein computer traffic related to the first computer includes incoming traffic that terminates after the grace time of inactivity and outgoing traffic that terminates after the grace period of inactivity.
